(19) United States
(12) Patent Application Publication
(10) Pub. No.: US 2026/0113355 A1
(43) Pub. Date: Apr. 23, 2026

(54) ARTIFICIAL INTELLIGENCE BASED REQUEST CLASSIFICATION FOR SECURITY POLICY APPLICATION

(71) Applicant: International Business Machines Corporation, Armonk, NY (US)

(72) Inventors: Shriti Priya, WHITE PLAINS, NY (US); Julian James Stephen, Yorktown Heights, NY (US); Arjun Natarajan, Old Tappan, NJ (US)

(21) Appl. No.: 18/924,320

(22) Filed: Oct. 23, 2024

(51) Int. Cl. H04L 9/40

(52) U.S. Cl. CPC H04L 63/20

(57) ABSTRACT

Mechanisms for implementing security policies in data processing system. The mechanisms receive a request for an application or application programming interface (API) and extracts request information from the request. A large language model (LLM) tagging prompt is generated based on the extracted request information. The LLM tagging prompt requests a security semantic tagging operation by the LLM. The LLM tagging prompt is processed by a LLM and returns a response that specifies one or more security semantic tags applicable to the request. The security semantic tag(s) are correlated with one or more matching predefined security policies, and an output is generated based on the security semantic tag(s) and the one or more matching predefined security policies.

The following disclosure(s) are submitted under 35 U.S.C. 102(b)(1)(A):

DISCLOSURE(S): “Application-Aware Layer-7 Security Framework for Cloud APIs Using Large Language Models”, Julian James Stephen and Shriti Priya, The Linux Foundation Open Source Summit North America, Apr. 17, 2024, 29 pages.

### BACKGROUND

The present application relates generally to an improved data processing apparatus and method and more specifically to an improved computing tool and improved computing tool operations/functionality for artificial intelligence (AI) based request classification for security policy application.

Enterprises and organizations today are increasingly deploying in-house, cloud based applications and utilizing large numbers of these applications and their corresponding application programming interfaces (APIs), Such applications and APIs, while cloud based, may be deployed by such enterprises and organizations for both internal operations and external customer use. Cloud based applications vary greatly and may include financial cloud based systems, research systems, health care systems, and other key systems and services used in society. Each of the cloud based applications may have their own separately developed APIs, nomenclatures, and the like.

Cloud based application deployments deal with increasing numbers of threats, despite security features offered by cloud service providers. Thus, ensuring that these applications and their APIs are secure from such threats, e.g., attacks, data leaks, and other misuse, while remaining available for their intended use, is a primary concern to modern enterprises and organizations.

### SUMMARY

This Summary is provided to introduce a selection of concepts in a simplified form that are further described herein in the Detailed Description. This Summary is not intended to identify key factors or essential features of the claimed subject matter, nor is it intended to be used to limit the scope of the claimed subject matter.

In one illustrative embodiment, a computer-implemented method for implementing security policies in a data processing system. The method comprises receiving a request for an application or application programming interface (API) of the data processing system. The method further comprises extracting request information from the request, and generating at least one first large language model (LLM) tagging prompt, based on the extracted request information, which requests a security semantic tagging operation by the LLM. The method also comprises submitting the at least one first LLM tagging prompt to a LLM for processing. In addition, the method comprises receiving at least one response to the at least one first LLM tagging prompt from the LLM, where the at least one response specifies one or more security semantic tags applicable to the request. Furthermore, the method comprises correlating the one or more security semantic tags with one or more matching predefined security policies. Moreover, the method comprises generating an output based on the one or more security semantic tags and the one or more matching predefined security policies.

In other illustrative embodiments, a computer program product comprising a computer useable or readable medium having a computer readable program is provided. The computer readable program, when executed on a computing device, causes the computing device to perform various ones of, and combinations of, the operations outlined above with regard to the method illustrative embodiment.

In yet another illustrative embodiment, a system/apparatus is provided. The system/apparatus may comprise one or more processors and a memory coupled to the one or more processors. The memory may comprise instructions which, when executed by the one or more processors, cause the one or more processors to perform various ones of, and combinations of, the operations outlined above with regard to the method illustrative embodiment.

These and other features and advantages of the present invention will be described in, or will become apparent to those of ordinary skill in the art in view of, the following detailed description of the example embodiments of the present invention.

### BRIEF DESCRIPTION OF THE DRAWINGS

The invention, as well as a preferred mode of use and further objectives and advantages thereof, will best be understood by reference to the following detailed description of illustrative embodiments when read in conjunction with the accompanying drawings, wherein:

FIG. 1 is a diagram illustrating one example of how two different APIs may utilize different semantics to refer to a similar operation or concept;

FIG. 2 is an example diagram of a distributed data processing system environment in which aspects of the illustrative embodiments may be implemented and at least some of the computer code involved in performing the inventive methods may be executed;

FIG. 3 is an example block diagram illustrating the primary operational components of a Large Language Model (LLM) based security policy semantic tagging system in accordance with one illustrative embodiment;

FIG. 4 is an example diagram illustrating a structure of an LLM tagging prompt in accordance with one illustrative embodiment;

FIG. 5 is a diagram illustrating an example of a system prompt portion of an LLM tagging prompt for a multi-class classification in accordance with one illustrative embodiment;

FIGS. 6A-6G are examples of system prompts for single class classification by an LLM for various types of classes in accordance with one illustrative embodiment; and

FIG. 7 is a flowchart outlining an example operation for performing LLM based security semantic tagging and correlation with security policies in accordance with one illustrative embodiment.

### DETAILED DESCRIPTION

The illustrative embodiments provide an improved computing tool and improved computing tool operations/functionality for artificial intelligence (AI) based request classification for security policy application. As noted above, the proliferation of cloud based applications and Application Programming Interfaces (APIs) has increased over time with the convenience and availability of a wide variety of applications from which more complex systems may be built. However, this leads to significant security issues as each application and API is a potential source of security vulnerabilities. Thus, it is incumbent upon enterprises and organizations to invest heavily into security teams that can identify such security vulnerabilities across a wide variety of applications and APIs that may be employed by such enterprises and organizations. This is a daunting task when one considers that each application and API may be developed independent of other applications and APIs and may use their own nomenclature for referencing similar actions, operations, data, and the like, i.e., each application/API may have its own semantics. Moreover, these applications and APIs may have voluminous amounts of coding, where even a single line of code can provide a security vulnerability that may be exploited by bad actors.

In large enterprises and organizations, it is impractical to expect a human being to be knowledgeable with regard to every application and API and their individual ways of referencing actions, operations, data, and the like. Thus, it is difficult for a human being to be able to write security policies that are applicable to every application and API. That is, one set of security features and policies may not fit all cross-domain applications. Thus, it is not currently possible to be able to set forth cluster (the set of cloud based applications and APIs) wide security policies for threat prevention and mitigation since each individual application and API's semantics are not known to the security personnel without significant efforts. The security personnel must investigate each application and API to determine how that particular application or API references particular actions, operations, data, and the like, i.e., the particular application's or API's semantics, and determine how to customize security policies to that particular application or API. This is a time consuming and costly process that is beset with a plethora of opportunities for human error. Moreover, it leads to security policy bloat as it requires a separate security policy for each application and/or API that uses its own semantics.

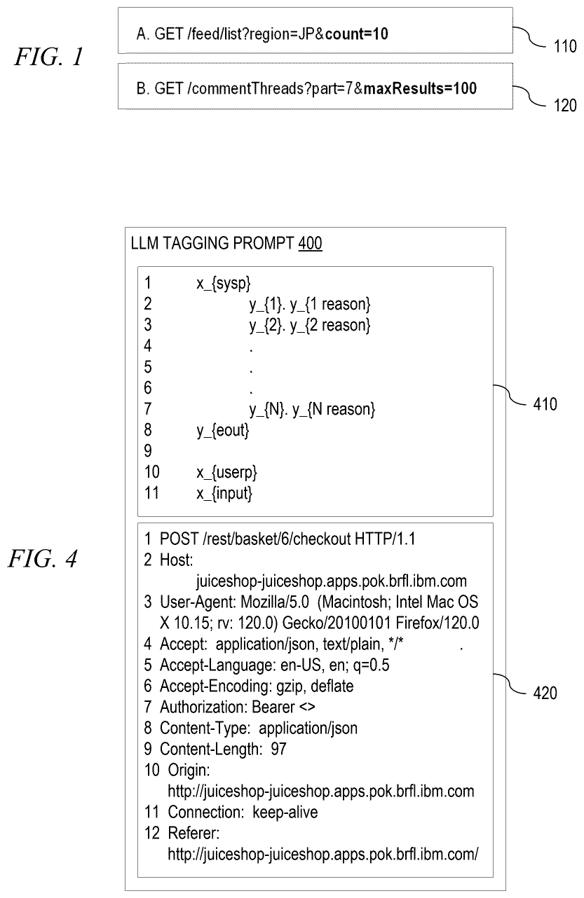

FIG. 1 is a diagram illustrating one example of how two different APIs may utilize different semantics to refer to a similar operation or concept. In the example of FIG. 1, two different API operations are shown for retrieving response records. In the first API operation 110, the number of response records returned is referred to as “count=10”, whereas in the second API operation 120, the number of response records returned is referred to as “maxResults=100”. If a security analyst wants to establish a security policy that limits the number of records that can be returned, such as to prevent certain security threats that may attempt to return large numbers of records (e.g., 10,000 records) to try to cause the application to fail, then the security analyst would need to know the various semantics and syntax of how each application and API in the entire cluster of cloud based applications and APIs references the number of records that are returned. As the number of applications in the cluster increases, this becomes increasingly impractical to do, especially when one considers all the possible security threats and all the possible ways that applications and APIs may reference similar actions, operations, data, and concepts using their own syntax and semantics.

Moreover, the same security policies and thresholds do not necessarily apply to every application or API invocation. For example, an API invocation threshold for #purchase_item is not necessarily applicable to an API invocation of #login_attempt. That is, one may not want to apply the same threshold of 5 to both #login_attempt and #purchase_item. While this threshold may be perfectly reasonable to apply to the #login_attempt API invocation to try to prevent security threats that seek to attack the application by making large numbers of login attempts, it is not reasonable to limit users' ability to purchase items such that they can only purchase at most 5 items.

Thus, it would be beneficial to have an automated mechanism through which application and API requests may be classified with regard to their semantically significant context and correlate the individual application and API requests to security policies based on these semantically significant contexts. In this way, the individual semantics of the applications and APIs may be correlated with generalizable security policy contexts to thereby identify which security policies are applicable to the various application and API requests. This will allow security analysts to be presented with the security policies applicable to each individual application or API request regardless of the individual semantics and apply the appropriate security policies without having to customize the security policies to each individual application or API. This enables cluster wide security policies to be developed and automatically applied without having to know the individual application or API semantics or syntax. Moreover, this enables security analysts to identify application or API requests for which security policies may not be available and which need to be developed, as well as the security policy semantics that are most applicable to these applications or API requests.

In some illustrative embodiments, the improved computing tool and improved computing tool operations/functionality includes a large language model (LLM) based security policy semantic tagging system that automatically processes and tags the submitted application or API requests, e.g., HyperText Transfer Protocol (HTTP) requests or the like. The tagging mechanisms leverage the pre-trained machine learning computer model capabilities of the LLM, along with a specially generated LLM tagging prompt having a system prompt portion that is static across all LLM tagging prompts and an application/API request specific prompt portion that is variable. The security policy semantic tags may then be correlated with security policies defined in terms of the security policy semantic tags to thereby identify a set of security policies, if any, that are applicable to the particular submitted request.

In operation, the application or API request, hereafter assumed to be an HTTP request, targeting an application or API is intercepted by a proxy layer, which is a layer of computer logic that sits before the application or API. The proxy layer forwards the request to the LLM-based security policy semantic tagging system, hereafter referred to as the “tagging system” for simplicity. In one or more illustrative embodiments, the tagging system may be implemented as a Web Assembly (WASM) module, for example, but may be implemented using other techniques and mechanisms in other illustrative embodiments.

The tagging system extracts relevant information from the request, e.g., the header, body, and the like, which are then appended to the system prompt portion of the LLM tagging prompt, as the request-specific prompt portion of the LLM tagging prompt. The LLM tagging prompt is then submitted to the LLM for inference and one or more applicable security semantic tags, from a plurality of predefined security semantic tags, are issued, if found, for the request. If a security semantic tag that is applicable to the request is not found by the LLM in response to the LLM tagging prompt, then the request may be tagged with a default security semantic tag of “None” or the like, and no automatic identification of applicable security policies and execution of such security policies is performed. Otherwise, if at least one security semantic tag is issued by the LLM for the request, then one or more applicable security policies corresponding to the at least one security semantic tag may be retrieved from a security policy repository and presented to a security analyst via a user interface, and/or in some illustrative embodiments automatically executed on the request.

That is, in some illustrative embodiments, the request may be extended by adding an additional header that indicates the security semantic tag(s) issued by the LLM in response to the LLM tagging prompt. The additional header is appended to the original request and the request is then forwarded to a security policy enforcement system, such as an Open Policy Agent (OPA) or other WASM based module which applies the appropriate security policies for those security semantic tags in the header of the modified request.

In some illustrative embodiments, the tagging system includes a request cache which stores the requests that are processed by the tagging system and the particular security semantic tags issued by the LLM in response to the LLM tagging prompts for these requests, so as to map requests to security semantic tags. The request cache may be shared across different threads via a shared memory mechanism. In this way, the request cache may be first accessed prior to generating and submitting the LLM tagging prompt, so as to determine if a previous request with the same header and body already has been processed by the tagging system. If there is a cache hit, then the corresponding security semantic tag(s) may be retrieved from the request cache and used instead of requiring LLM processing of an LLM tagging prompt.

To increase the interpretability of the reason behind a specific security semantic tag that has been issued or assigned to a particular request, an asynchronous request to the same LLM may be issued with a same seed value (used for tagging) but with a larger token size to provide an explanation of the issued security semantic tag. The request type and reason for the decision may be stored in a database for later retrieval. This is not part of the request processing path, and is only to provide visibility for a decision by the LLM, such as in the case of subsequent auditing or investigation.

It should be appreciated that the LLM operates on the LLM tagging prompt such that the particular semantics of the particular request are encapsulated in the request-specific prompt portion of the LLM tagging prompt, with the system prompt being common to all LLM tagging prompts. In this way, the system prompt causes the LLM to generate tags that are cross-domain and applicable to multiple applications and APIs, whereas the request-specific prompt portion customizes the LLM operation to the particular request. Once tagged with the applicable predefined security semantic tags, which are applicable across all the applications and APIs, the security policies applicable to those tags may be more easily identifiable and in some cases automatically executed, regardless of the individual application or API syntax and semantics. In this way, the illustrative embodiments provide an improved computing tool and improved computing tool operations/functionality for applying security policies in a cluster wide manner across a variety of applications and APIs.

Moreover, the illustrative embodiments enable system administrators to compose security policies more easily by utilizing a relatively small number of predefined security semantic classifications which correspond to security semantic tags, rather than having to have detailed subject matter expert specific knowledge of individual application and API syntax and semantics. The LLM, based on the specific LLM tagging prompts of the illustrative embodiments, performs the complex and arduous work of determining the security semantic classifications, and thus security semantic tags, that are applicable to given requests and then correlates those request with the pre-defined security policies which are defined in terms of these security semantic tags.

Before continuing the discussion of the various aspects of the illustrative embodiments and the improved computer operations performed by the illustrative embodiments, it should first be appreciated that throughout this description the term “mechanism” will be used to refer to elements of the present invention that perform various operations, functions, and the like. A “mechanism,” as the term is used herein, may be an implementation of the functions or aspects of the illustrative embodiments in the form of an apparatus, a procedure, or a computer program product. In the case of a procedure, the procedure is implemented by one or more devices, apparatus, computers, data processing systems, or the like. In the case of a computer program product, the logic represented by computer code or instructions embodied in or on the computer program product is executed by one or more hardware devices in order to implement the functionality or perform the operations associated with the specific “mechanism.” Thus, the mechanisms described herein may be implemented as specialized hardware, software executing on hardware to thereby configure the hardware to implement the specialized functionality of the present invention which the hardware would not otherwise be able to perform, software instructions stored on a medium such that the instructions are readily executable by hardware to thereby specifically configure the hardware to perform the recited functionality and specific computer operations described herein, a procedure or method for executing the functions, or a combination of any of the above.

The present description and claims may make use of the terms “a”, “at least one of”, and “one or more of” with regard to particular features and elements of the illustrative embodiments. It should be appreciated that these terms and phrases are intended to state that there is at least one of the particular feature or element present in the particular illustrative embodiment, but that more than one can also be present. That is, these terms/phrases are not intended to limit the description or claims to a single feature/element being present or require that a plurality of such features/elements be present. To the contrary, these terms/phrases only require at least a single feature/element with the possibility of a plurality of such features/elements being within the scope of the description and claims.

Moreover, it should be appreciated that the use of the term “engine,” if used herein with regard to describing embodiments and features of the invention, is not intended to be limiting of any particular technological implementation for accomplishing and/or performing the actions, steps, processes, etc., attributable to and/or performed by the engine, but is limited in that the “engine” is implemented in computer technology and its actions, steps, processes, etc. are not performed as mental processes or performed through manual effort, even if the engine may work in conjunction with manual input or may provide output intended for manual or mental consumption. The engine is implemented as one or more of software executing on hardware, dedicated hardware, and/or firmware, or any combination thereof, that is specifically configured to perform the specified functions. The hardware may include, but is not limited to, use of a processor in combination with appropriate software loaded or stored in a machine readable memory and executed by the processor to thereby specifically configure the processor for a specialized purpose that comprises one or more of the functions of one or more embodiments of the present invention. Further, any name associated with a particular engine is, unless otherwise specified, for purposes of convenience of reference and not intended to be limiting to a specific implementation. Additionally, any functionality attributed to an engine may be equally performed by multiple engines, incorporated into and/or combined with the functionality of another engine of the same or different type, or distributed across one or more engines of various configurations.

In addition, it should be appreciated that the following description uses a plurality of various examples for various elements of the illustrative embodiments to further illustrate example implementations of the illustrative embodiments and to aid in the understanding of the mechanisms of the illustrative embodiments. These examples intended to be non-limiting and are not exhaustive of the various possibilities for implementing the mechanisms of the illustrative embodiments. It will be apparent to those of ordinary skill in the art in view of the present description that there are many other alternative implementations for these various elements that may be utilized in addition to, or in replacement of, the examples provided herein without departing from the spirit and scope of the present invention.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

It should be appreciated that certain features of the invention, which are, for clarity, described in the context of separate embodiments, may also be provided in combination in a single embodiment. Conversely, various features of the invention, which are, for brevity, described in the context of a single embodiment, may also be provided separately or in any suitable sub-combination.

The present invention may be a specifically configured computing system, configured with hardware and/or software that is itself specifically configured to implement the particular mechanisms and functionality described herein, a method implemented by the specifically configured computing system, and/or a computer program product comprising software logic that is loaded into a computing system to specifically configure the computing system to implement the mechanisms and functionality described herein. Whether recited as a system, method, of computer program product, it should be appreciated that the illustrative embodiments described herein are specifically directed to an improved computing tool and the methodology implemented by this improved computing tool. In particular, the improved computing tool of the illustrative embodiments specifically provides mechanisms to automatically tag requests with regard to their determined security semantic contexts and correlate the tags with security policies that are applicable to the request. The improved computing tool implements mechanism and functionality, such as a large language model (LLM) based security policy semantic tagging system, which cannot be practically performed by human beings either outside of, or with the assistance of, a technical environment, such as a mental process or the like. The improved computing tool provides a practical application of the methodology at least in that the improved computing tool is able to correlate application and/or API requests with security policies regardless of the individual customized semantics and syntax of the requests.

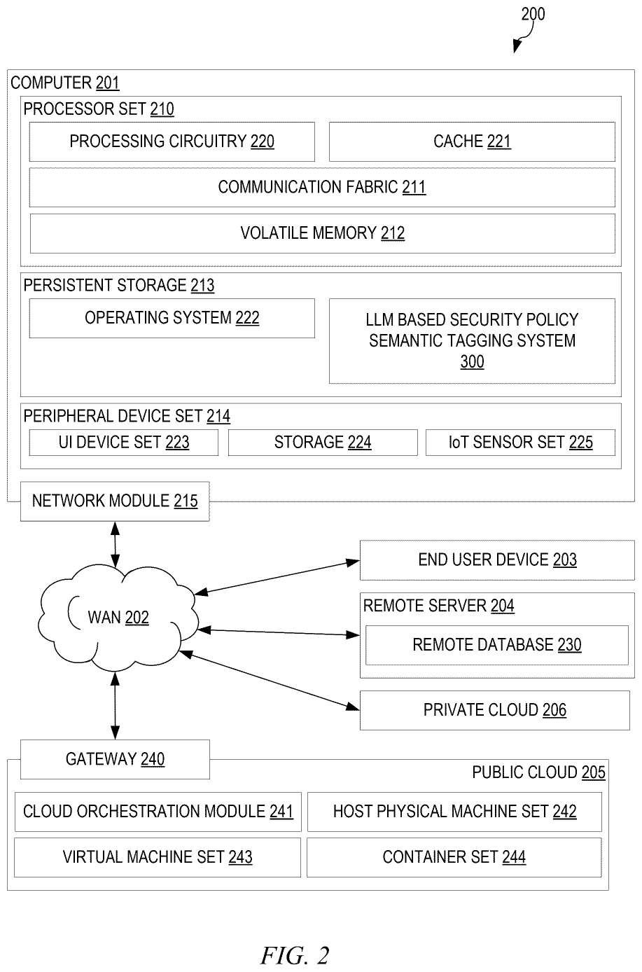

FIG. 2 is an example diagram of a distributed data processing system environment in which aspects of the illustrative embodiments may be implemented and at least some of the computer code involved in performing the inventive methods may be executed. That is, computing environment 200 contains an example of an environment for the execution of at least some of the computer code involved in performing the inventive methods, such as LLM based security policy semantic tagging system 300. In addition to LLM based security policy semantic tagging system 300, computing environment 200 includes, for example, computer 201, wide area network (WAN) 202, end user device (EUD) 203, remote server 204, public cloud 205, and private cloud 206. In this embodiment, computer 201 includes processor set 210 (including processing circuitry 220 and cache 221), communication fabric 211, volatile memory 212, persistent storage 213 (including operating system 222 and LLM based security policy semantic tagging system 300, as identified above), peripheral device set 214 (including user interface (UI), device set 223, storage 224, and Internet of Things (IoT) sensor set 225), and network module 215. Remote server 204 includes remote database 230. Public cloud 205 includes gateway 240, cloud orchestration module 241, host physical machine set 242, virtual machine set 243, and container set 244.

Computer 201 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 230. As is well understood in the art of computer technology, and depending upon the technology, performance of a computer-implemented method may be distributed among multiple computers and/or between multiple locations. On the other hand, in this presentation of computing environment 200, detailed discussion is focused on a single computer, specifically computer 201, to keep the presentation as simple as possible. Computer 201 may be located in a cloud, even though it is not shown in a cloud in FIG. 2. On the other hand, computer 201 is not required to be in a cloud except to any extent as may be affirmatively indicated.

Processor set 210 includes one, or more, computer processors of any type now known or to be developed in the future. Processing circuitry 220 may be distributed over multiple packages, for example, multiple, coordinated integrated circuit chips. Processing circuitry 220 may implement multiple processor threads and/or multiple processor cores. Cache 221 is memory that is located in the processor chip package(s) and is typically used for data or code that should be available for rapid access by the threads or cores running on processor set 210. Cache memories are typically organized into multiple levels depending upon relative proximity to the processing circuitry. Alternatively, some, or all, of the cache for the processor set may be located “off chip.” In some computing environments, processor set 210 may be designed for working with qubits and performing quantum computing.

Computer readable program instructions are typically loaded onto computer 201 to cause a series of operational steps to be performed by processor set 210 of computer 201 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 221 and the other storage media discussed below. The program instructions, and associated data, are accessed by processor set 210 to control and direct performance of the inventive methods. In computing environment 200, at least some of the instructions for performing the inventive methods may be stored in LLM based security policy semantic tagging system 300 in persistent storage 213.

Communication fabric 211 is the signal conduction paths that allow the various components of computer 201 to communicate with each other. Typically, this fabric is made of switches and electrically conductive paths, such as the switches and electrically conductive paths that make up busses, bridges, physical input/output ports and the like. Other types of signal communication paths may be used, such as fiber optic communication paths and/or wireless communication paths.

Volatile memory 212 is any type of volatile memory now known or to be developed in the future. Examples include dynamic type random access memory (RAM) or static type RAM. Typically, the volatile memory is characterized by random access, but this is not required unless affirmatively indicated. In computer 201, the volatile memory 212 is located in a single package and is internal to computer 201, but, alternatively or additionally, the volatile memory may be distributed over multiple packages and/or located externally with respect to computer 201.

Persistent storage 213 is any form of non-volatile storage for computers that is now known or to be developed in the future. The non-volatility of this storage means that the stored data is maintained regardless of whether power is being supplied to computer 201 and/or directly to persistent storage 213. Persistent storage 213 may be a read only memory (ROM), but typically at least a portion of the persistent storage allows writing of data, deletion of data and re-writing of data. Some familiar forms of persistent storage include magnetic disks and solid state storage devices. Operating system 222 may take several forms, such as various known proprietary operating systems or open source Portable Operating System Interface type operating systems that employ a kernel. The code included in LLM based security policy semantic tagging system 300 typically includes at least some of the computer code involved in performing the inventive methods.

Peripheral device set 214 includes the set of peripheral devices of computer 201. Data communication connections between the peripheral devices and the other components of computer 201 may be implemented in various ways, such as Bluetooth connections, Near-Field Communication (NFC) connections, connections made by cables (such as universal serial bus (USB) type cables), insertion type connections (for example, secure digital (SD) card), connections made through local area communication networks and even connections made through wide area networks such as the internet. In various embodiments, UI device set 223 may include components such as a display screen, speaker, microphone, wearable devices (such as goggles and smart watches), keyboard, mouse, printer, touchpad, game controllers, and haptic devices. Storage 224 is external storage, such as an external hard drive, or insertable storage, such as an SD card. Storage 224 may be persistent and/or volatile. In some embodiments, storage 224 may take the form of a quantum computing storage device for storing data in the form of qubits. In embodiments where computer 201 is required to have a large amount of storage (for example, where computer 201 locally stores and manages a large database) then this storage may be provided by peripheral storage devices designed for storing very large amounts of data, such as a storage area network (SAN) that is shared by multiple, geographically distributed computers. IoT sensor set 225 is made up of sensors that can be used in Internet of Things applications. For example, one sensor may be a thermometer and another sensor may be a motion detector.

Network module 215 is the collection of computer software, hardware, and firmware that allows computer 201 to communicate with other computers through WAN 202. Network module 215 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 215 are performed on the same physical hardware device. In other embodiments (for example, embodiments that utilize software-defined networking (SDN)), the control functions and the forwarding functions of network module 215 are performed on physically separate devices, such that the control functions manage several different network hardware devices. Computer readable program instructions for performing the inventive methods can typically be downloaded to computer 201 from an external computer or external storage device through a network adapter card or network interface included in network module 215.

WAN 202 is any wide area network (for example, the internet) capable of communicating computer data over non-local distances by any technology for communicating computer data, now known or to be developed in the future. In some embodiments, the WAN may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

End user device (EUD) 203 is any computer system that is used and controlled by an end user (for example, a customer of an enterprise that operates computer 201), and may take any of the forms discussed above in connection with computer 201. EUD 203 typically receives helpful and useful data from the operations of computer 201. For example, in a hypothetical case where computer 201 is designed to provide a recommendation to an end user, this recommendation would typically be communicated from network module 215 of computer 201 through WAN 202 to EUD 203. In this way, EUD 203 can display, or otherwise present, the recommendation to an end user. In some embodiments, EUD 203 may be a client device, such as thin client, heavy client, mainframe computer, desktop computer and so on.

Remote server 204 is any computer system that serves at least some data and/or functionality to computer 201. Remote server 204 may be controlled and used by the same entity that operates computer 201. Remote server 204 represents the machine(s) that collect and store helpful and useful data for use by other computers, such as computer 201. For example, in a hypothetical case where computer 201 is designed and programmed to provide a recommendation based on historical data, then this historical data may be provided to computer 201 from remote database 230 of remote server 204.

Public cloud 205 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 205 is performed by the computer hardware and/or software of cloud orchestration module 241. The computing resources provided by public cloud 205 are typically implemented by virtual computing environments that run on various computers making up the computers of host physical machine set 242, which is the universe of physical computers in and/or available to public cloud 205. The virtual computing environments (VCEs) typically take the form of virtual machines from virtual machine set 243 and/or containers from container set 244. It is understood that these VCEs may be stored as images and may be transferred among and between the various physical machine hosts, either as images or after instantiation of the VCE. Cloud orchestration module 241 manages the transfer and storage of images, deploys new instantiations of VCEs and manages active instantiations of VCE deployments. Gateway 240 is the collection of computer software, hardware, and firmware that allows public cloud 205 to communicate through WAN 202.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

Private cloud 206 is similar to public cloud 205, except that the computing resources are only available for use by a single enterprise. While private cloud 206 is depicted as being in communication with WAN 202, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 205 and private cloud 206 are both part of a larger hybrid cloud.

As shown in FIG. 2, one or more of the computing devices, e.g., computer 201 or remote server 204, may be specifically configured to implement a LLM based security policy semantic tagging system 300. The configuring of the computing device may comprise the providing of application specific hardware, firmware, or the like to facilitate the performance of the operations and generation of the outputs described herein with regard to the illustrative embodiments. The configuring of the computing device may also, or alternatively, comprise the providing of software applications stored in one or more storage devices and loaded into memory of a computing device, such as computer 201 or remote server 204, for causing one or more hardware processors of the computing device to execute the software applications that configure the processors to perform the operations and generate the outputs described herein with regard to the illustrative embodiments. Moreover, any combination of application specific hardware, firmware, software applications executed on hardware, or the like, may be used without departing from the spirit and scope of the illustrative embodiments.

It should be appreciated that once the computing device is configured in one of these ways, the computing device becomes a specialized computing device specifically configured to implement the mechanisms of the illustrative embodiments and is not a general purpose computing device. Moreover, as described hereafter, the implementation of the mechanisms of the illustrative embodiments improves the functionality of the computing device and provides a useful and concrete result that facilitates automatic security semantic classification and tagging with correlation to security policies for presentation to security analysts or other authorized personnel and/or automatic execution of security policies.

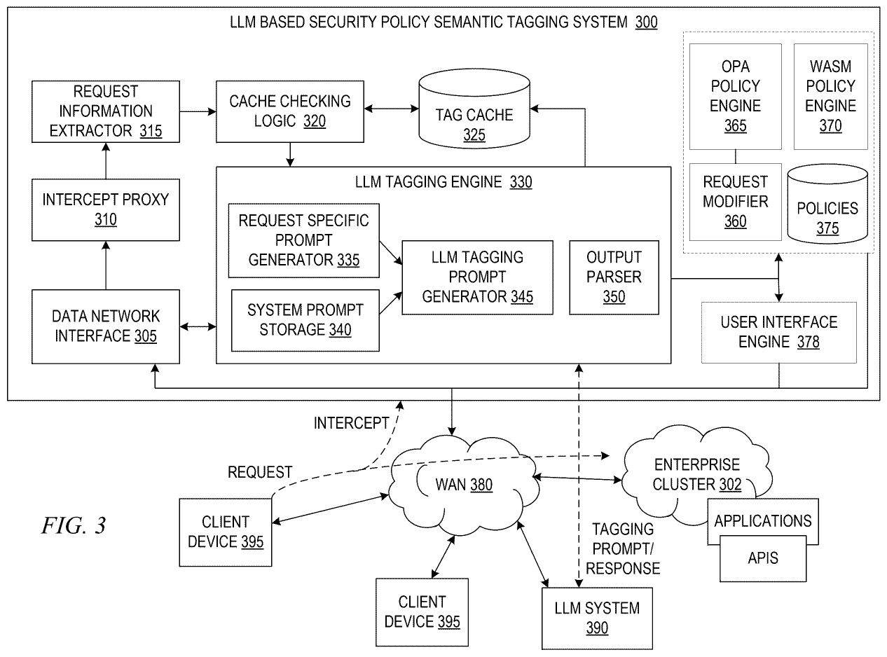

FIG. 3 is an example block diagram illustrating the primary operational components of a LLM based security policy semantic tagging system in accordance with one illustrative embodiment. The operational components shown in FIG. 3 may be implemented as dedicated computer hardware components, computer software executing on computer hardware which is then configured to perform the specific computer operations attributed to that component, or any combination of dedicated computer hardware and computer software configured computer hardware. It should be appreciated that these operational components perform the attributed operations automatically, without human intervention, even though inputs may be provided by human beings, e.g., application and/or API requests, and the resulting output may aid human beings, e.g., outputs of applicable security policies, reasons for security semantic tags applied to requests, and the like. The invention is specifically directed to the automatically operating computer components directed to improving the way that security policies are generated and applied to application and/or API requests, especially with regard to cloud-based systems for enterprises and organizations, and provides a specific solution that implements automatic security semantic tagging and security policy correlation which cannot be practically performed by human beings as a mental process and is not directed to organizing any human activity.

As shown in FIG. 3, the large language model (LLM) based security policy semantic tagging system 300 includes a data network interface 305, intercept proxy 310, request information extractor 315, cache checking logic 320, tag cache 325, LLM tagging engine 330, security policy enforcement mechanisms 360-375, and user interface engine 378. The LLM tagging engine 330 further includes a request specific prompt generator 335, system prompt storage 340, LLM tagging prompt generator 345, and output parser 350. The security policy enforcement mechanisms 360-375 comprises an optional request modifier 360 and OPA policy engine interface 365, an optional Web Assembly (WASM) policy engine 370, and a security policies repository 375, one or more of which may be provided in separate computing systems or separate sub-systems of the same computing systems apart from the LLM based security policy semantic tagging system 300 (or simply “tagging system” 300), but accessible by the tagging system 300. Moreover, these are only examples of the types of security policy enforcement mechanisms with which the tagging system 300 of the illustrative embodiments may operate and is not intended to limit the present invention to only OPA and WASM security policy enforcement mechanisms. The illustrative embodiments may be implemented with any suitable currently available or later developed security policy enforcement mechanisms which have been adapted to implement security policies defined in accordance with the predefined security semantic categories and corresponding security semantic tags of the illustrative embodiments.

The tagging system 300 operates on requests, e.g., HyperText Transfer Protocol (HTTP) requests or the like, submitted by client devices 395, via one or more data networks (e.g., local area networks (LANs) and/or wide area networks (WANs) 385, to applications and/or Application Programming Interfaces (APIs) of an enterprise cluster 302, where the enterprise cluster 302 is a collection of a plurality of applications and APIs, such as cloud based applications and their corresponding APIs. The requests from the client devices 395 may be calls to the corresponding applications/APIs for performance of various operations, such as performing login operations, logout operations, adding items to a cart in an e-commerce application, performing a search of a database and returning records, purchasing a product in an e-commerce application, uploading a file, commenting on a portion of content, or any of a plethora of other computer operations. The tagging system 300 operates to leverage the LLM system 390 to perform automatic tagging of the requests from client devices 395, which are intercepted prior to reaching the applications/APIs of the enterprise cluster 302, with security semantic tags corresponding to predefined security semantic categories which are the basis for the defining of security policies. These tags may then be used to correlate the particular request with applicable security policies from the security policies repository 375 and/or present user interface(s), via the user interface engine 378, through which security analysts or other authorized personnel may be informed of the applicable security policies, if any, any violations of applicable security policies by the request, and/or present tools through which security policies may be developed and written with the aid of the LLM based tagging of the request to identify which predefined security semantic categories and corresponding tags apply to the particular request. This is all done without the requirement that a human being or subject matter expert be aware of the particular semantics of the particular applications/APIs being invoked by the request.

In operation, client devices 395 may send requests, e.g., HTTP requests, for services or computer operations to the enterprise cluster 302 targeting particular applications and/or APIs of the cluster 302. These requests are intercepted by the intercept proxy 310 via the data network interface 305. While the intercept proxy 310 is shown as an element of the tagging system 300 in FIG. 3, it should be appreciated that in some illustrative embodiments, the intercept proxy 310 may be a layer of computer logic that sits before the applications/APIs of the enterprise cluster 302 and redirects the requests from the client devices 395 to the tagging system 300.

The intercept proxy 310 forwards the intercepted requests to the request information extractor 315 which extracts relevant information from the request, e.g., the header, body, and the like. The header and body of the request comprises a plurality of parameters that are extracted and used by the cache checking logic 320 to perform a lookup operation in the tag cache 325. That is, the tag cache 325 stores the parameters of requests and the corresponding security semantic tags assigned, by the LLM tagging engine 330 of the tagging system 300, to these requests. The cache checking logic 320 performs a lookup by attempting to match the parameters of the current request to those already stored in the tag cache 325. If there is a cache hit, then the corresponding security semantic tags stored in the matching entry of the tag cache 325 may be retrieved and utilized without having to perform the LLM based tagging via the LLM tagging engine 330. If there is not a cache hit, then the operation of the tagging system proceeds with LLM based tagging via the LLM tagging engine 330.

In some illustrative embodiments, for LLM tagging, the method and path from a HTTP request header is extracted as part of the relevant information from the request. The method and path are concatenated to a generate a string that is converted to a hash key. Consider the following example:

GET /search?q=test HTTP/1.1
Host: www.example.com
User-Agent: Mozilla/5.0 (Windows NT 10.0; Win64; x64) AppleWebKit/537.36
(KHTML, like Gecko) Chrome/91.0.4472.124 Safari/537.36
Accept: text/html,application/xhtml+xml,application/xml;q=0.9,image/webp,/;q=0.8
Accept-Language: en-US,en;q=0.5
Connection: keep-alive

In the above request, the method (GET) and path (/search?q=test H) are extracted and concatenated (GET/search?q=test H) and this combination is sent to a hash function to generate a hash value for the key value store in the tag cache 325, where key is the hash key generated, and value is the LLM tag for that method and path combination. Thus, if the same method and path combination are later encountered, then the tag cache 325 will generate a cache hit and the corresponding LLM tags for that method and path combination may be retrieved.

Assuming that the there is a cache miss in the tag cache 325, the extracted request information, e.g., the extracted header and body parameters, are submitted to the LLM tagging engine 330. The LLM tagging engine 330 comprises a LLM tagging prompt generator 345 that generates an LLM tagging prompt by combining a static system prompt from the system prompt storage 340 with a request specific prompt that is generated by the request specific prompt generator 335 from the extracted request information. That is, the request specific prompt generator 335 populates fields of a request prompt with the specific parameters extracted from the request by the request information extractor 315 to generate a request specific prompt. This request specific prompt is then appended to the system prompt retrieved from the system prompt storage 340. The resulting LLM tagging prompt, generated by the LLM prompt generator 345, is then submitted to the LLM system 390 via the data network interface 305 for processing by an LLM. The LLM of the LLM system 390 returns an output specifying the particular security semantic tag(s) that the LLM has determined are applicable to the particular request based on the LLM tagging prompt.

The LLM of the LLM system 390 operates on the LLM tagging prompt in a zero-shot manner, meaning that the LLM is not pre-trained for security semantic tagging of requests and instead is presented with the necessary contextual information in the LLM tagging prompt from which the LLM performs its operations. The LLM is pre-trained on a general corpus, e.g., content of the Internet or other large corpus of information, for more general applicability and the LLM tagging prompt provides the context by which the LLM applies this general applicability to the particular task security semantic tagging of requests in accordance with the illustrative embodiments. Thus, the LLM tagging prompt specifies the particular pre-defined security semantic tag(s) from which the LLM selects the ones that are applicable to the particular extracted request information specified in the request specific prompt portion of the LLM tagging prompt. Moreover, the LLM tagging prompt further specifies the reasoning that the LLM is to use when selecting the applicable security semantic tag(s), as well as the way in which the LLM is to present the output.

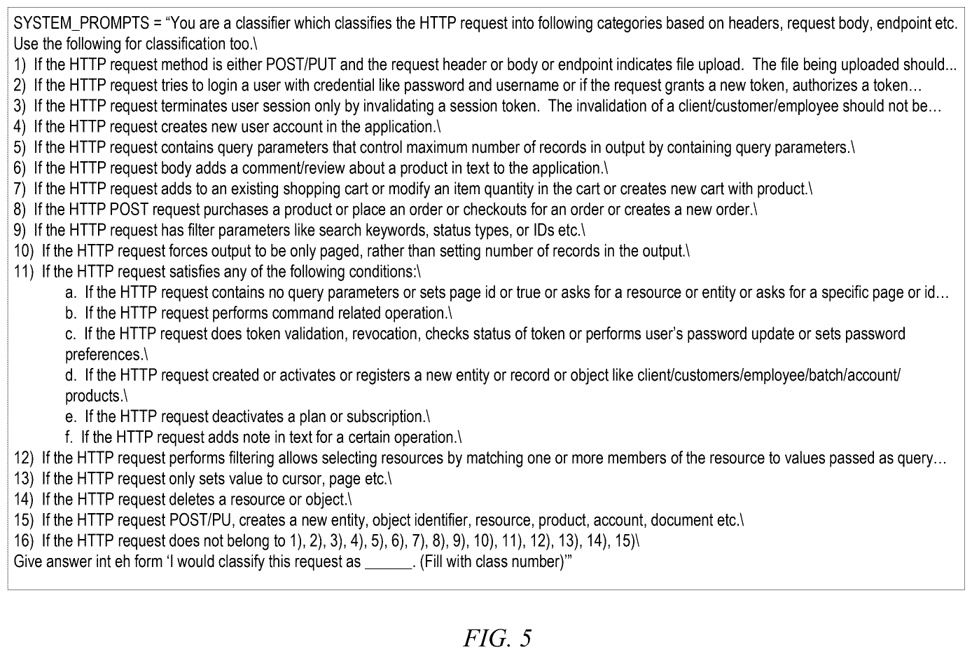

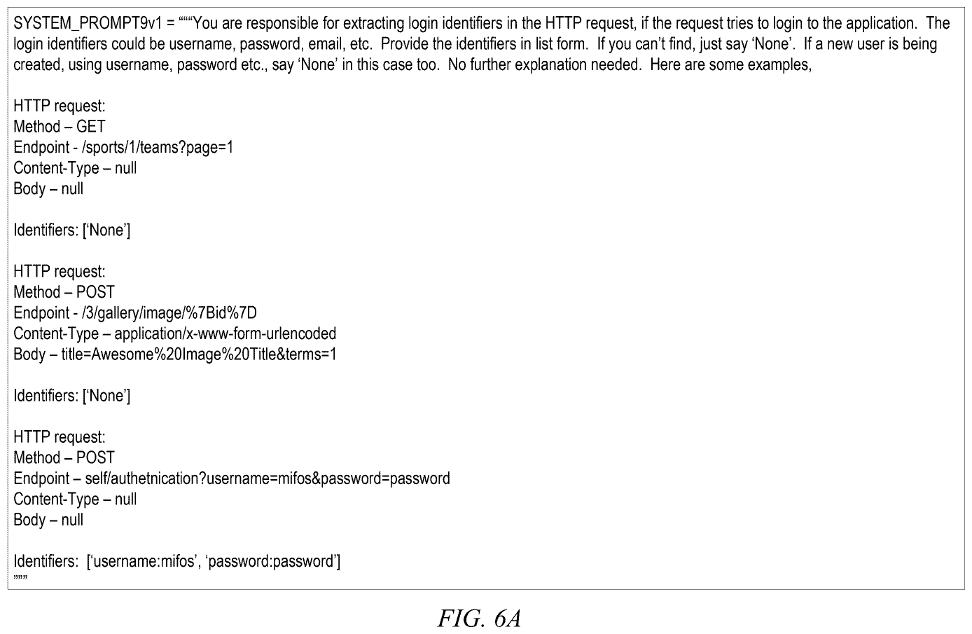

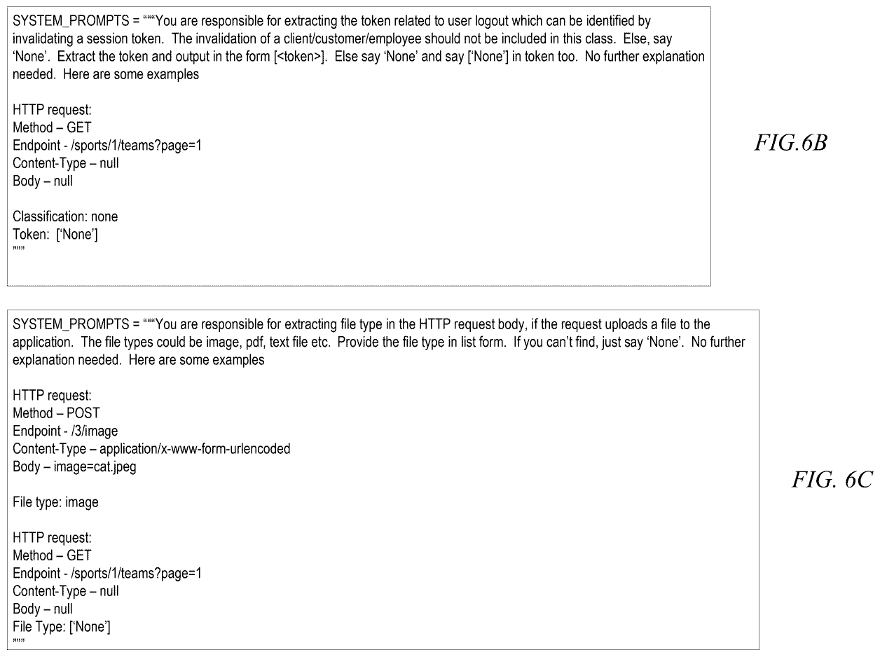

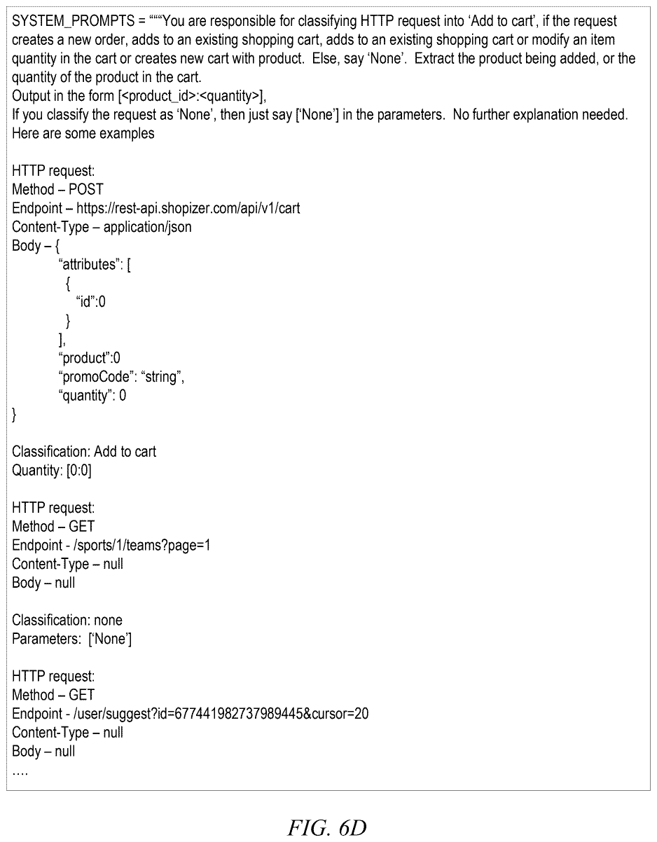

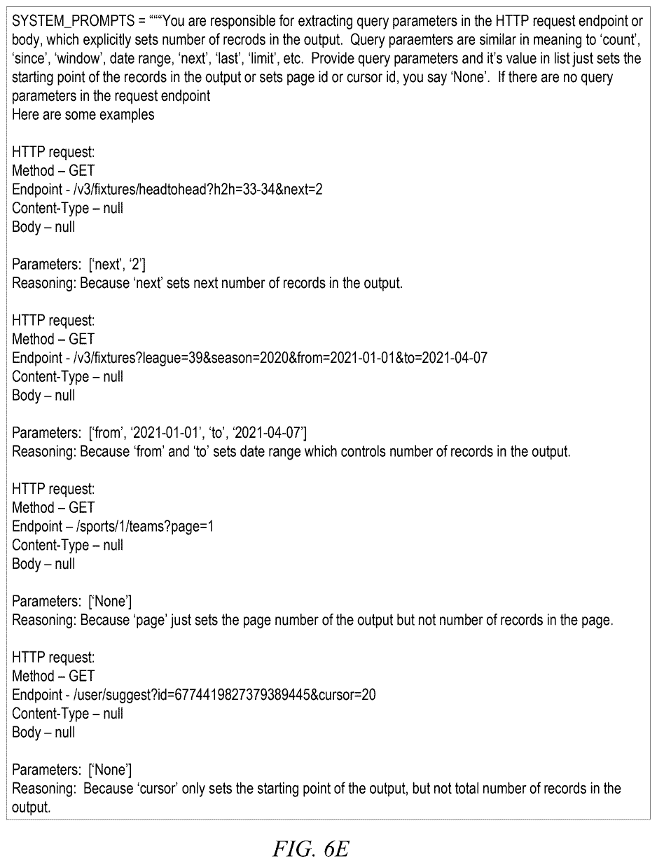

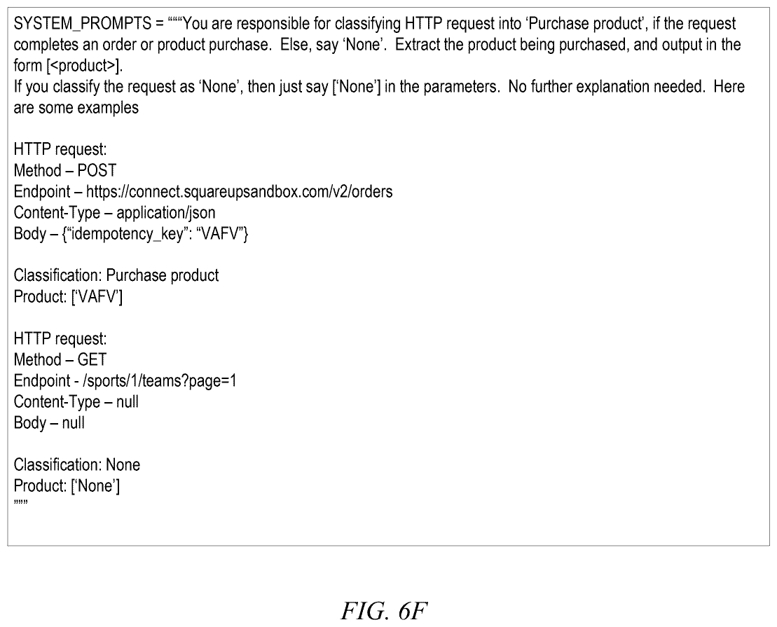

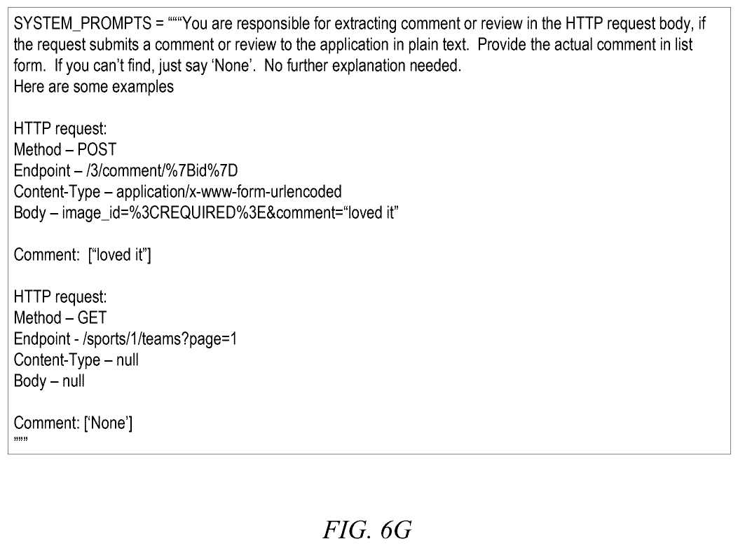

It should be appreciated that in some illustrative embodiments, the LLM tagging prompt may specify a plurality of security semantic classifications and corresponding security semantic tags, which is referred to herein as a multi-class classification prompt. In other illustrative embodiments, the LLM tagging prompt may be specific to a particular security semantic class and corresponding security semantic class, with multiple such LLM tagging prompts being submitted to the LLM, e.g., one for each of the pre-defined security semantic classes/tags. It has been determined that in some instances, such as where the reasoning becomes voluminous and complex, the LLM may perform better and provide more accurate results when single class LLM tagging prompts are utilized over the multi-class classification prompts, however this requires more prompts to be processed by the LLM. Examples of LLM tagging prompts, with regard to both multi-class classifications and single class classifications, will be provided hereafter with reference to FIGS. 5 and 6A-6G, with the general structure of a LLM tagging prompt being provided in FIG. 4.

The LLM of the LLM system 390 processes the LLM tagging prompt, or prompts in the case of single class classifications, and generates an output specifying the one or more applicable security semantic tags for the request, if found. If a security semantic tag that is applicable to the request is not found by the LLM in response to the LLM tagging prompt, then the request may be tagged with a default security semantic tag of “None” or the like. The resulting output of the LLM is received by the LLM tagging engine 330 which then parses the output via the output parser 350 to present the results information to the user interface engine 378 and/or the security policy enforcement mechanisms 360-375. The output parser 350 reads the output from the LLM which may contain unnecessary tokens or characters. The output parser 350 splits the result from the LLM to identify a tag, e.g., in the response “I would classify this request as 3”, the output parser 350 parses the number 3 to get the tag shown in FIG. 5, discussed hereafter.

The results of the LLM tagging performed by the LLM tagging engine 330 may be stored in the tag cache 325 for use with subsequent request processing by the tagging system 300. That is, as mentioned above, the cache checking logic 320 first looks to the tag cache 325 for a cache hit. Thus, by storing the results of the LLM tagging by the LLM tagging engine 330 in the tag cache 325 in association with the extracted request information, subsequent requests having the same or similar request information may be matched to a cache entry in the tag cache 325 and the corresponding applicable security semantic tags may be retrieved from the tag cache 325 without having to perform the LLM tagging via the LLM tagging engine 330 again. This increases the speed by which security semantic tags may be associated with requests for identify applicable security policies, as well as reduces the amount of computing resources required to do so.

The user interface engine 378 provides computer logic for generating user interfaces, e.g., graphical user interfaces (GUIs), and the like, through which authorized users may access information regarding the security semantic tags associated with requests, if any, the lack of security semantic tags applicable to requests, which security policies in the security policy repository 375 correspond to the security semantic tags automatically determined to be applicable to requests by the tagging system 300, the results of security policy enforcement based on the automatically determined security semantic tags and the previously defined security policies in the security policies repository 375, and the like. In cases where no security semantic tags are found to be applicable, this information may be presented via the user interfaces as well so that authorized personnel are informed of such. Moreover, in cases where a matching security policy, i.e., matched to the automatically determined security semantic tags, is not found, the security semantic tags for the request may be presented and the lack of a security policy may be noted to the authorized personnel so that they may utilize appropriate tools to define a security policy using the applicable security semantic tags automatically identified by the tagging system 300.

The security policy enforcement mechanisms 360-375 may operate to identify applicable security policies in the security policy repository 375 for presentation via the user interface engine 378 and/or for automatic execution to ensure that the request meets the requirements of the security policies prior to permitting the request to be processed at the applications/APIs of the enterprise cluster 302. Two possibilities are shown in FIG. 3 for implementing the security policies of the repository 375, i.e., an Open Policy Agent (OPA) and a Web Assembly (WASM) approach. In either case, security policies of the repository 375 may be executed against the request to determine if the request is in compliance with the applicable security policies. If the request meets the security policy requirements, then the request may be forwarded along to the targeted applications/APIs of the enterprise cluster 302. If the request does not meet the security policy requirements, then it may be blocked and a notification sent to appropriate authorized personnel of this security violation, such as via the user interface engine 378.

The WASM approach allows for the WASM policy engine 370 to execute the security policies of the repository 375 directly on the request. The OPA approach may require modification of the original request via the request modifier 360. This modification may be the extending of the original request by adding an additional header that indicates the security semantic tag(s) that are automatically assigned by the LLM in response to the LLM tagging prompt. The additional header is appended to the original request and the request is then processed by the OPA policy engine 365. It should be appreciated that while the OPA policy engine 365 and WASM policy engine 370 are shown as part of the tagging system 300, they may in fact be provided via a separate computing system or a separate sub-system of the same computing system on which the tagging system 300 is implemented. Moreover, the security policies repository 375 may also be on a separate computing system or separate sub-system. In such cases, interfaces may be provided for communicating and accessing these separately provided components.

As mentioned above, in some illustrative embodiments, in order to increase the interpretability of the reason behind a specific security semantic tag that has been issued or assigned to a particular request, an asynchronous request to the same LLM of the LLM system 390 may be issued by the LLM tagging engine 330 with a same seed value but with a larger token size to provide an explanation of the issued security semantic tag. The request type and reason for the decision may be stored in a database (not shown) for later retrieval. This is not part of the request processing path described above, and is only to provide visibility for a decision by the LLM, such as in the case of subsequent auditing or investigation.

As described above, the LLM of the LLM system 390 operates on the LLM tagging prompt generated by the LLM tagging engine 330, such that the particular semantics of the particular request are encapsulated in the request-specific prompt portion of the LLM tagging prompt, with the system prompt being common to all LLM tagging prompts. In this way, the system prompt causes the LLM to generate tags that are cross-domain applicable to all applications and APIs of the enterprise cluster 302, or even across clusters, whereas the request-specific prompt portion customizes the LLM operation to the particular request. Once tagged with the applicable predefined security semantic tags, which are applicable across all the applications and APIs, the security policies in the security policies repository 375 which are applicable to those tags may be more easily identifiable and in some cases automatically executed by the components 360-670, regardless of the individual application or API syntax and semantics. In this way, the illustrative embodiments provide an improved computing tool and improved computing tool operations/functionality for applying security policies in a cluster wide manner across a variety of applications and APIs.

Moreover, the illustrative embodiments enable system administrators to compose security policies more easily by utilizing a relatively small number of predefined security semantic classifications and corresponding security semantic tags, rather than having to have detailed subject matter expert specific knowledge of individual application and API syntax and semantics. The LLM of the LLM system 390, based on the specific LLM tagging prompts generated by the LLM tagging engine 330, performs the complex and arduous work of determining the security semantic classifications and corresponding security semantic tags that are applicable to given requests and then correlates those security semantic tags with the pre-defined security policies in the repository 375, which are defined in terms of these security semantic tags.

As discussed above, the LLM tagging prompt is composed of a static system prompt and a request specific prompt. FIG. 4 is an example diagram illustrating a structure of an LLM tagging prompt in accordance with one illustrative embodiment. The upper portion 410 of the LLM tagging prompt 400 is an example of a system prompt portion, whereas the lower portion 420 is an example of a request specific prompt. With regard to the system prompt portion 410, the x_{sysp} in line 1 is a text instruction to the LLM specifying what the overall role of the LLM is for the given task, e.g., for the given task of classifying a request into different security semantic classifications or categories, the text instruction may be of the type “You are a classifier which classifies the HTTP request into the following categories:”, or the like.

In lines 2-7, in one or more illustrative embodiments, the values yₙ are whole numbers, each being a class identification number assigned to a corresponding class. These class identification numbers are used to avoid LLMs having any bias based on class names before decision making is made, but may be correlated with class names and/or security semantic tags associated with these class identification numbers and class names.

Associated with each class identification number in lines 2-7 is also a class identification reasoning yₙᵣₑₐₛₒₙ. The class identification reasoning is a combination of primary reasoning, yₙₚᵣ, and additional clues, y_{nc}. The primary reasoning provides primary criteria for a class to be identified. The clues are provided to give additional information or context for the classification. The clues may be keywords, phrases, or the like, that can help identify a certain class. For example, for a File upload, the primary reasoning and clues may be of the type:
yₙₚᵣ: If the HTTP request uploads or adds an image/file to the application/server.
y_{nc}: The request should have file name or reference to file being uploaded.

The expected output, yₑₒᵤₜ, is specified in line 8 of the example system prompt 410. The expected output specifies the format in which the output is expected to be provided, e.g., yₑₒᵤₜ: Give answer in the form “I would classify this request as (Fill with class number)”. The user prompt, xᵤₛₑᵣₚ, in line 10 defines the prompt from the user whenever an input is provided for inference. The user prompt is specified by the request specific prompt 420. The input, xᵢₙₚᵤₜ, in line 11 is the HTTP request to classify, which his in a raw request format. It should be appreciated that the system prompt 410 is generally applicable to a plurality of requests and thus, is not request-specific.

The request specific prompt 420 comprises various parameters extracted from the raw request. For example, these parameters may be the request, e.g., POST/rest/basket/6/checkout, and the protocol HTTP/1.1. Other parameters may include the host, the user agent, the language, encoding, content-type, content-length, origin, connection type, referrer, and the like. These parameters are specific to the particular request being processed. Thus, the LLM tagging prompt comprises a combination of a static system prompt and a request specific prompt.

As mentioned above, the LLM tagging prompts may be provided as multi-class classification prompts or single class classification prompts in which a binary determination is made, e.g., either the single class applies or it does not. In either case, the structure of the LLM tagging prompt is as shown in FIG. 4. However, the content of the system prompt portions 410 differs between multi-class classifications and single class classifications.

FIG. 5 is a diagram illustrating an example of a system prompt portion of an LLM tagging prompt for a multi-class classification in accordance with one illustrative embodiment. As shown in FIG. 5, the system prompt for a multi-class classification operation includes a plurality of pre-defined classes, e.g., 1-16 in the depicted example, along with their corresponding reasoning for classifying a request into the corresponding class. These pre-defined classes represent the predefined security semantic classifications that the LLM is able to select from when determining the applicable security semantic tag(s) applicable to a given request. The security semantic tag(s) may be the class identification numbers, a class name corresponding to the class identification numbers, or the like. A separate mapping data structure may be used to map the class identification numbers to corresponding class names and security semantic tags, for example. Again, the numerical class identification numbers are to ensure that the LLM does not introduce bias prior to classification based on the terms used in class names, however the use of class identification numbers in place of class names is not a requirement for the illustrative embodiments or the present invention.

FIGS. 6A-6G are examples of system prompts for single class classification by an LLM for various types of classes in accordance with one illustrative embodiment. FIG. 6A is an example system prompt for a login request. FIG. 6B is an example system prompt for a logout request. FIG. 6C is an example system prompt for a file upload request. FIG. 6D is an example system prompt for an “add to cart” request. FIG. 6E is an example system prompt for a response records request. FIG. 6F is an example system prompt for a “purchase product” request. FIG. 6G is an example system prompt for a comment or review request. These are single class prompts used for information/parameter extraction. Given a class attached to a request, these prompts are used to extract parameters related to that class, which can be used in policy enforcement. Each example in FIGS. 6A-6G show different reasoning and output formats on information extraction related to class/tag. Thus, as can be seen from these examples, the system prompts are specific to individual security semantic classes and set forth the specific primary reasoning and clues for determining whether the particular individual security semantic class applies to the given request. The clues are provided in terms of examples.

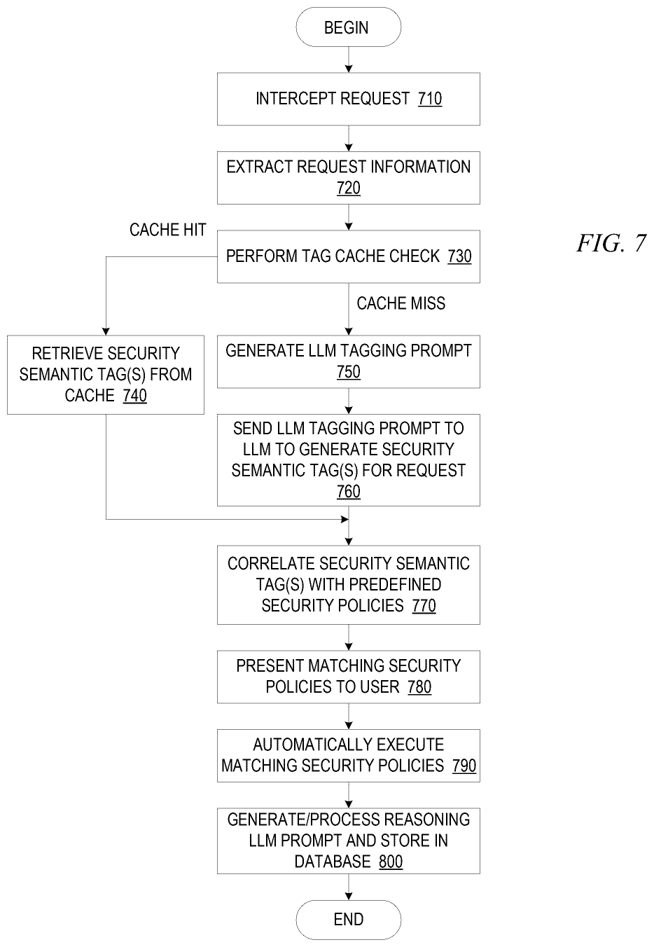

FIG. 7 presents a flowchart outlining example operations of elements of the present invention with regard to one or more illustrative embodiments. It should be appreciated that the operations outlined in FIG. 7 are specifically performed automatically by an improved computer tool of the illustrative embodiments and are not intended to be, and cannot practically be, performed by human beings either as mental processes or by organizing human activity. To the contrary, while human beings may, in some cases, initiate the performance of the operations set forth in FIG. 7, and may, in some cases, make use of the results generated as a consequence of the operations set forth in FIG. 7, the operations in FIG. 7 themselves are specifically performed by the improved computing tool in an automated manner.

FIG. 7 is a flowchart outlining an example operation for performing LLM based security semantic tagging and correlation with security policies in accordance with one illustrative embodiment. As shown in FIG. 7, the operation starts by intercepting a request, via an interception proxy, targeting an application or API (step 710). The request is processed to extract request information, e.g., header and body parameters (step 720). A check of a tag cache is performed based on the extracted request information to determine if the same or similar request has been previously tagged with security semantic tags (step 730). If there is a cache hit, the corresponding security semantic tags are retrieved from the tag cache (step 740). If there is not a cache hit, i.e., there is a cache miss, then a LLM tagging prompt is generated based on a static system prompt portion and a request specific prompt portion which is specific to the extracted request features (step 750). The LLM tagging prompt is sent to an LLM which processes the LLM tagging prompt and returns one or more applicable security semantic tags or returns a “none” response (step 760).

If there is a tag cache hit, or after the LLM tagging response is received, the operation performs a correlation of the applicable security semantic tags with predefined security policies, if any (step 770). The matching security policies are presented to an authorized user via a user interface (step 780). In some illustrative embodiments, matching security policies may be automatically executed to ensure that the received request abides by existing security policies (step 790). Moreover, a reasoning LLM tagging prompt may also be submitted to the LLM to obtain more reasoning information for why the LLM generated the security semantic tag(s) and the resulting information is stored in a database for later use (step 800). The operation then terminates.

The description of the present invention has been presented for purposes of illustration and description, and is not intended to be exhaustive or limited to the invention in the form disclosed. Many modifications and variations will be apparent to those of ordinary skill in the art without departing from the scope and spirit of the described embodiments. The embodiment was chosen and described in order to best explain the principles of the invention, the practical application, and to enable others of ordinary skill in the art to understand the invention for various embodiments with various modifications as are suited to the particular use contemplated. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A computer-implemented method for implementing security policies in a data processing system, the method comprising:
receiving a request for an application or application programming interface (API) of the data processing system;
extracting request information from the request;
generating at least one first large language model (LLM) tagging prompt, based on the extracted request information, which requests a security semantic tagging operation by the LLM;
submitting the at least one first LLM tagging prompt to a LLM for processing;
receiving at least one response to the at least one first LLM tagging prompt from the LLM, wherein the at least one response specifies one or more security semantic tags applicable to the request;
correlating the one or more security semantic tags with one or more matching predefined security policies; and
generating an output based on the one or more security semantic tags and the one or more matching predefined security policies.

2. The computer-implemented method of claim 1, wherein each first LLM tagging prompt in the at least one first LLM tagging prompt comprises a system prompt portion that is static across a plurality of LLM tagging prompts, and which specifies at least one predefined security semantic classification, and a request specific prompt portion that is specific to the extracted request information.

3. The computer-implemented method of claim 1, wherein the request information comprises header information specifying at least one of a method and a path.

4. The computer-implemented method of claim 3, wherein the method and path are concatenated and input to a hashing function to generate a hash value for a key value store of a tagging cache, and wherein the hash value is stored in the tagging cache in association with the one or more security semantic tags.

5. The computer-implemented method of claim 1, wherein the output comprises content specifying the one or more matching predefined security policies.

6. The computer-implemented method of claim 1, further comprising automatically executing the one or more matching predefined security policies on the request to determine if the request is in compliance with the one or more matching predefined security policies, wherein the output comprises an indicator of whether the request is in compliance with the one or more matching predefined security policies.

7. The computer-implemented method of claim 6, wherein automatically executing the one or more matching predefined security policies comprises:
appending the one or more security semantic tags to a header of the request to thereby generate an extended request; and
forwarding the extended request to a security policy enforcement system, wherein correlating the one or more security semantic tags with one or more matching predefined security policies is performed by the security policy enforcement system based on the one or more security semantic tags in the extended request.

8. The computer-implemented method of claim 1, further comprising:
performing a cache lookup in a tagging cache based on the request information extracted from the request to determine if there is a matching entry in the tagging cache; and
in response to there being a cache hit in the tagging cache, retrieving one or more corresponding cached security semantic tags from the matching entry to be the one or more security semantic tags.

9. The computer-implemented method of claim 1, wherein the at least one first LLM tagging prompt comprises a plurality of first LLM tagging prompts, each first LLM tagging prompt being associated with a different classification of request type.

10. The computer-implemented method of claim 1, further comprising submitting at least one subsequent LLM tagging prompt, based on the at least one first LLM tagging prompt, but with a relatively larger token size than the at least one first LLM tagging prompt, to thereby generate reasoning information, and storing the reasoning information in association with an indicator of the at least one first LLM tagging prompt in a database.

11. A computer program product comprising a computer readable storage medium having a computer readable program stored therein, wherein the computer readable program, when executed in a data processing system, causes the data processing system to:
receive a request for an application or application programming interface (API) of the data processing system;
extract request information from the request;
generate at least one first large language model (LLM) tagging prompt, based on the extracted request information, which requests a security semantic tagging operation by the LLM;
submit the at least one first LLM tagging prompt to a LLM for processing;
receive at least one response to the at least one first LLM tagging prompt from the LLM, wherein the at least one response specifies one or more security semantic tags applicable to the request;
correlate the one or more security semantic tags with one or more matching predefined security policies; and
generate an output based on the one or more security semantic tags and the one or more matching predefined security policies.

12. The computer program product of claim 11, wherein each first LLM tagging prompt in the at least one first LLM tagging prompt comprises a system prompt portion that is static across a plurality of LLM tagging prompts, and which specifies at least one predefined security semantic classification, and a request specific prompt portion that is specific to the extracted request information.

13. The computer program product of claim 11, wherein the request information comprises header information specifying at least one of a method and a path.

14. The computer program product of claim 13, wherein the method and path are concatenated and input to a hashing function to generate a hash value for a key value store of a tagging cache, and wherein the hash value is stored in the tagging cache in association with the one or more security semantic tags.

15. The computer program product of claim 11, wherein the output comprises content specifying the one or more matching predefined security policies.

16. The computer program product of claim 11, further comprising automatically executing the one or more matching predefined security policies on the request to determine if the request is in compliance with the one or more matching predefined security policies, wherein the output comprises an indicator of whether the request is in compliance with the one or more matching predefined security policies.

17. The computer program product of claim 16, wherein automatically executing the one or more matching predefined security policies comprises:
appending the one or more security semantic tags to a header of the request to thereby generate an extended request; and
forwarding the extended request to a security policy enforcement system, wherein correlating the one or more security semantic tags with one or more matching predefined security policies is performed by the security policy enforcement system based on the one or more security semantic tags in the extended request.

18. The computer program product of claim 11, further comprising:
performing a cache lookup in a tagging cache based on the request information extracted from the request to determine if there is a matching entry in the tagging cache; and
in response to there being a cache hit in the tagging cache, retrieving one or more corresponding cached security semantic tags from the matching entry to be the one or more security semantic tags.

19. The computer program product of claim 11, wherein the at least one first LLM tagging prompt comprises a plurality of first LLM tagging prompts, each first LLM tagging prompt being associated with a different classification of request type.

20. An apparatus comprising:
at least one processor; and
at least one memory coupled to the at least one processor, wherein the at least one memory comprises instructions which, when executed by the at least one processor, cause the at least one processor to:
receive a request for an application or application programming interface (API) of the data processing system;
extract request information from the request;
generate at least one first large language model (LLM) tagging prompt, based on the extracted request information, which requests a security semantic tagging operation by the LLM;
submit the at least one first LLM tagging prompt to a LLM for processing;
receive at least one response to the at least one first LLM tagging prompt from the LLM, wherein the at least one response specifies one or more security semantic tags applicable to the request;
correlate the one or more security semantic tags with one or more matching predefined security policies; and
generate an output based on the one or more security semantic tags and the one or more matching predefined security policies.
